(19) United States
(12) Patent Application Publication
(10) Pub. No.: US 2003/0163381 A1
(43) Pub. Date: Aug. 28, 2003

(54) Method of procuring a component

(76) Inventor: John M. Spangler, Edwards, IL (US)

Correspondence Address: CATERPILLAR INC., 100 N.E. ADAMS STREET, PATENT DEPT., PEORIA, IL, 616296490

(21) Appl. No.: 10/083,423

(22) Filed: Feb. 26, 2002

(51) Int. Cl. G06F 17/60

(52) U.S. Cl. 705/26

(57) ABSTRACT

The present invention includes a method of procuring a component, and includes the steps of establishing a bid criteria, responding to the bid criteria, identifying at least one potential supplier, submitting a first bid request to the identified supplier, receiving a response from the supplier, comparing the bid response with the bid criteria, modifying the bid criteria, establishing a second bid request in response to the modified bid criteria, establishing at least one potential supplier associated with subcomponents, submitting said second bid request to identified potential suppliers and selecting solicited suppliers in response to associated bid responses.

### TECHNICAL FIELD

This invention relates generally to a method and apparatus of procuring a component and more particularly to a method and apparatus of procuring a component having subcomponents.

### BACKGROUND

There are systems, such as paint and material handling systems, which companies need to develop in order to perform job related functions associated with the business objectives of the company. However, the company may not have the expertise to design and/or procure the system themselves. In these circumstances, there are several ways a company may procure these systems. For example, the company may select a turnkey supplier to design and install the system or process. The responsibilities of the turnkey supplier include supplying the detailed engineering drawings, coordinating contractors for fabrication and installation, providing training to the client and when completed the system or process is turned over to the client. However, turnkey systems are very costly. Another approach may be the company designs their system and develops associated specifications. This approach includes designing the system, preparing the bid specifications, identifying capable equipment and system suppliers, submitting the specifications to the suppliers, evaluating the quotes received from the suppliers and selecting the supplier for fabrication. The success of this approach depends on the knowledge of the companies' system designers. Depending on the system involved, a company may only build one of these systems every 5 to 10 years, meaning the company may lack the design expertise to build such a system. Another approach involves the company selecting an engineering firm to design the system or process. In this instance the engineering firm designs the system for the client, prepares the bid specifications for the equipment or process. Next the engineering firm identifies qualified suppliers for the company and submits specifications to qualified suppliers for quotes. The quotes from the suppliers are evaluated and the qualified or low bidder is selected for turnkey installation. However, as indicated, turnkey systems are very costly. Generally there may be a sizeable profit associated with the turnkey system, for the supplier. Generally the purchasing company is unable to understand the details of what is needed to develop the system, and therefore relies on the turnkey system. The purchase of a turnkey system then results in a large expenditure for the system.

In addition, systems such as paint and material handling systems, conveyor belt systems etc., are custom systems. Therefore the requirements placed on suppliers may change from one system to the next. Using pre-determined suppliers will not identify which supplier is in a good position to meet the procurement needs for this particular system. The result is an overpriced, and possibly functionally inferior system.

The present invention is directed to overcoming one or more of the problems set forth above.

### SUMMARY OF THE INVENTION

In one aspect of the present invention, a method of procuring a component is disclosed. The method includes the steps of establishing a bid criteria for the component, establishing a first bid request for providing to at least one potential supplier of the component, identifying at least one potential supplier for the component, submitting the bid request to at least one potential supplier, receiving a bid response from at least one potential supplier, comparing the bid response with the bid criteria, determining the bid response is undesirable in response to the comparison, modifying the bid criteria in response to the bid response being undesirable, establishing a second bid request in response to the modified bid criteria, identifying at least one-second potential supplier, submitting the second bid request to at least one-second potential supplier, receiving the bid response from at least one of the second potential suppliers and selecting at least one of the second potential suppliers to supply at least one of the component, or a subcomponent of the component in response to the second bid response.

### BRIEF DESCRIPTION OF THE DRAWINGS

FIG. 1 is an illustration of one embodiment of a method of procuring a component; and

FIG. 2 is an illustration of another embodiment of a method of procuring a component.

### DETAILED DESCRIPTION

The present invention provides a method of procuring at least one component associated with a system. In one embodiment, the system is a paint and material handling system. However, the method associated with this invention may apply to the procurement of any system having multiple components that are procured (e.g. conveyor belt systems etc.). In one embodiment, the systems are custom systems. A component is a part or service associated with the system. The component may be a uni-part, meaning that the component may not be broken down into sub components. Alternatively the component may be comprised of multiple sub components. The sub components may be assembled to form the components. In one embodiment, the components or sub-components, may be purchased or fabricated.

In one embodiment bill of material engineering is performed and given to at least one supplier. This bill of material engineering may be a detailed engineering specification for a component on either the highest or lowest level of complexity or any level of specification in-between. For example the bill of material engineering on a telephone may include a detailed engineering specification on the entire telephone or broken down into components like the receiver, buttons, speaker, wiring, plastic case etc. The component may be broken down until it may not be broken down anymore. In some systems subcomponents may be broken further down into other subcomponents. In another example, a bill of material associated with a wash booth may include the entire wash booth or individual components making up the wash booth. By providing the bill of material engineering to the supplier, the supplier does not have to perform the detailed engineering and associated design work, thereby reducing the cost of the component that the supplier may provide. The bill of material engineering may provide detailed engineering to such a degree that it replaces a traditional written description or is used in conjunction with traditional written descriptions.

A design of the system may be established. The system design is established based on the performance and functional objectives of the system. In one embodiment, the system design may have an associated desired system design cost. In addition, the design includes multiple components that are used to form the system. In one embodiment, each, or at least a portion, of the components of the system have an associated performance and function objectives. The components, or at least a portion of them, may have an associated desired cost. In one embodiment, the desired component cost is established in response to the desired system cost. In an alternative embodiment, the desired component cost may be established in response to a previous cost associated with the component or an analogous component. As mentioned, the components may also include subcomponents. In one embodiment, the system cost may be established in response to one or more of the desired component cost.

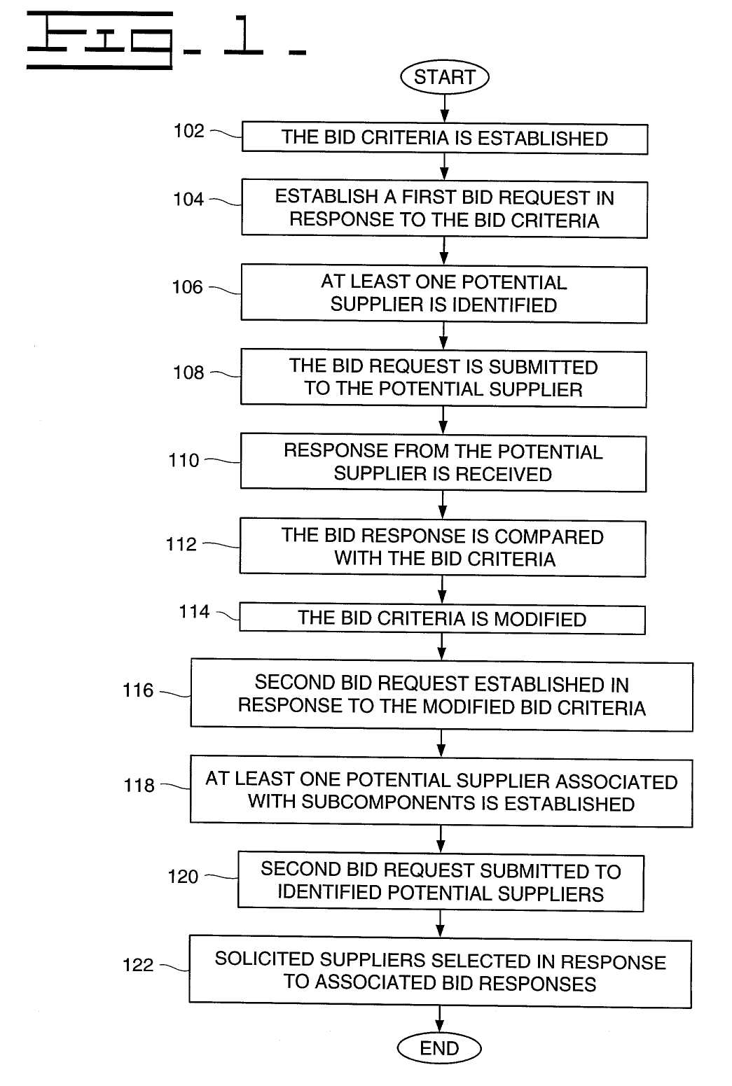

FIG. 1 illustrates one embodiment of a method of the present invention. In a first control block 102, a bid criteria may be established for one of the components of the system. The bid criteria may be based on the functional and performance objectives of a component. In addition, the bid criteria may be based on the desired cost of the system, and/or the desired cost of one or more of the components.

In a second control block 104, a first bid request associated with a component, is established in response to the bid criteria. A bid request is a request that is prepared for submission to one or more potential suppliers to provide the suppliers with the information needed to submit a bid, which may include engineering specifications. In one embodiment, the bid request is the same as the bid criteria. The bid request may include information associated with the bill of material engineering. Alternatively the bid request includes all or portions of the bid request, along with additional information. In a third control block 106, at least one potential supplier, associated with a component, is identified to submit the bid request to. In one embodiment, the potential supplier(s) are identified based on previous use of the supplier, previous submission of bids to the supplier, or some other identification process for a supplier. In an alternative embodiment, as will be discussed, the bid request may be an open bid request that is made available to any supplier who wishes to bid on the request.

In a fourth control block 108, the bid request is submitted to the identified potential supplier(s). In one embodiment, the submission may occur by mailing the bid request to the potential suppliers. Alternatively the request may be submitted to the potential supplier(s) electronically, e.g., e-mail, fax, or by a web-site posting. In a fifth control block 110, at least one response from the potential supplier(s) is received.

In a sixth control block 112, the received bid response(s) is compared with the bid criteria. In one embodiment a bid response associated with a component is compared with the performance objectives, functional objectives, and desired cost of the bid criteria associated with the component. If the bid response associated with a component does not meet the performance, functional, and/or cost objectives of the bid criteria associated with the component, the bid response is considered to be unacceptable, or undesirable. In one embodiment, the bid response may include bids associated with multiple components. Therefore, the performance, function, and cost of the proposed component is compared with the corresponding performance, function, and cost objectives of the system component. In one embodiment, within the same bid response there may be bid responses associated with proposed components that are acceptable, and bid responses associated with proposed components that are unacceptable.

In a seventh control block 114, the bid criteria is modified in response to the bid response(s) associated with a particular component being found to be unacceptable. That is, there was no bid response associated with a system component, which was found to meet the bid criteria, e.g., the performance, functional, and/or cost objectives of the component. In one embodiment, the bid criteria may be modified based upon the sub-components associated with the component. That is, if no bid response associated with a particular component, was acceptable, then the component may be broken down into a plurality of subcomponents. Then, the performance, functional, and cost objectives of the sub-component may be established, and used to develop a modified bid criteria. The modified bid criteria is established such that it includes a bid criteria associated with one or more of the sub-components.

In an eighth control block 116, a second bid request may be established in response to the modified bid criteria. The second bid request may include information associated with the modified bid criteria. In one embodiment, the second bid request includes bid criteria associated with one or more of the sub-components. For example, the second bid request may include a request to purchase a sub-component, fabricate a sub-component, and/or assemble the sub-component with one or more sub-components to form the component.

In a ninth control block 118, at least one potential supplier associated with one or more of the sub-components is established. The supplier may be the same as one of the previous solicited suppliers. Alternatively, the supplier may not have been solicited with the bid request.

In a tenth control block 120, the second bid request may be submitted to the identified potential supplier(s).

In an eleventh control block 122, a bid response is received from at least one of the identified suppliers.

In a twelfth control block 122, one of the solicited suppliers may be selected in response to their associated bid responses. In one embodiment, once a supplier is selected, the components and/or subcomponents may be ordered.

In one embodiment, when the sub-components are procured, they may be assembled into the associated component. Alternatively, a supplier (for example) may be hired to receive the sub components, assemble them, and deliver the assembled component to the requesting party. The procured sub-components and components may be assembled into the system.

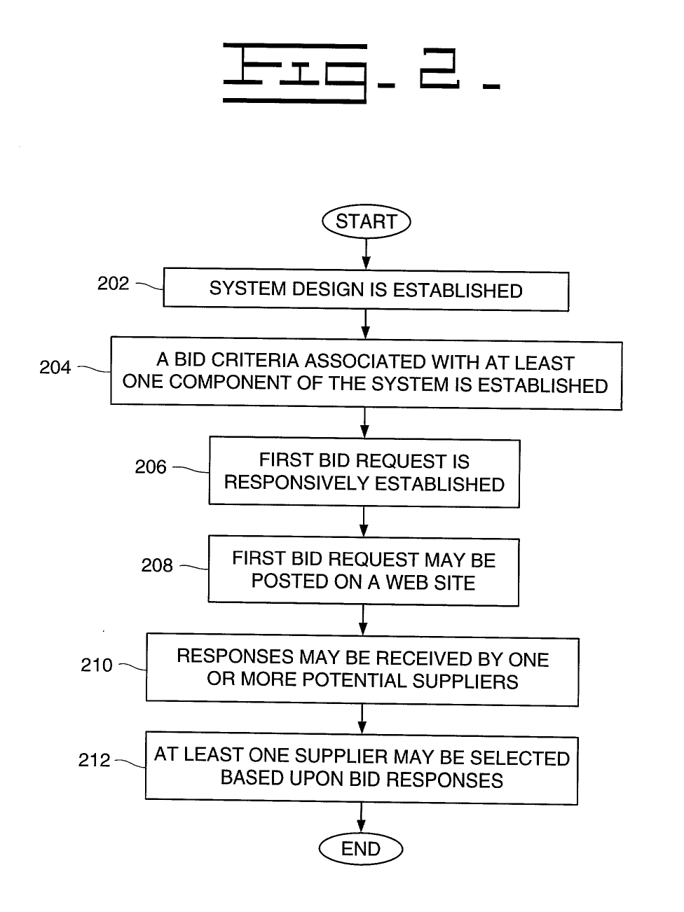

In one embodiment of the present invention, a computer-based method of procuring at least one component associated with a system is disclosed, as illustrated in FIG. 2. In a first control block 202 a system design may be established. The system has one or more associated components. In addition, at least one of the components has one or more sub-components associated with it. Once a system design is established, a bid criteria associated with at least one of the components is established, and a bid request is responsively established in control blocks 204 and 206 respectively. Control blocks 204 and 206 are analogous to the method performed in control blocks 104 and 106 respectively. In a fourth control block 208, the bid request may be posted on a web site. In one embodiment, access to the web site may be controlled. For example, only preferred suppliers may have access to the web site. In an alternative embodiment, the web site may be open to the public, and the posting may be an open bid. An open bid is a bid that is open to any supplier who would like to submit a bid. In one embodiment, the posting may include one or more bid requests associated with one or more bid criteria respectively. Multiple bid requests may be posted at any given time, and may be in different phases of the bidding process. In one embodiment, the posting will include a time period in which to respond. After the designated time period, for example, the posting may be removed. In this manner, the computer-based method may be viewed as a universal bidding process because the method enables suppliers throughout the world to bid on the requested bids.

In a fifth control block 210, one or more potential suppliers may submit a response. In one embodiment, the response may be received electronically, e.g., e-mail, or posted on the web site. In a sixth control block 212, at least one supplier may be selected based upon the bid responses.

In one embodiment, the bid responses may be compared with the bid request and/or bid criteria, as discussed above. If none of the received bid responses associated with a component are found to be acceptable, then the bid criteria may be modified, as discussed relative to the seventh control block 114 of FIG. 1. That is, there was no bid response associated with a system component, which was found to meet the bid criteria, e.g., the performance, functional, and/or cost objectives of the component. In one embodiment, the bid criteria may be modified based upon the sub-components associated with the component. Then, the performance, functional, and cost objectives of the sub-component may be established. The modified bid criteria are established such that it includes a bid criteria associated with one or more of the sub-components. Upon modification of the bid criteria, a second bid request may be established and posted on the web. The received bid request may then be reviewed, and a supplier selected in response to the bid request, analogous to control block 122 discussed above. The components and sub-components may be procured (including fabricated if necessary) from the selected supplier, and assembled into the system.

Industrial Applicability

The present invention includes a method of procuring a component, and more particularly, to a method of procuring a component associated with a system. The method includes the steps of establishing a bid criteria, responding to the bid criteria, identifying at least one potential supplier, submitting a first bid request to the identified supplier, receiving a response from the supplier, comparing the bid response with the bid criteria, modifying the bid criteria, establishing a second bid request in response to the modified bid criteria, establishing at least one potential supplier associated with subcomponents, submitting said second bid request to identified potential suppliers and selecting solicited suppliers in response to associated bid responses.

In one embodiment, the system is a custom system, such as a paint and material handling system. However, the method associated with this invention apply to the procurement of any system having multiple components that are procured. In another embodiment, the system design may have an associated desired system design cost. Additionally, the design includes multiple components that are used to form the system.

In one example, the system may be a mechanical pencil sharpener. A mechanical pencil sharpener, may include a base, a pair of blades that sharpen the pencil when rotated, a handle for turning the blades, an assembly to mount the base, blades and handle into, and mounting bolts to secure the pencil sharpener during operation. In this example, a bid criteria associated with the pencil sharpener may be established. The bid criteria may have a performance, functional, and/or cost objective associated with it. Upon comparison of the returned bid response(s), with the bid criteria, it may be determined that none of the components (e.g., the proposed pencil sharpeners) met the cost objectives of the bid criteria, i.e., all of the proposed sharpeners cost more than desired. Therefore, the bid criteria may be modified in response to the bid response(s) being unacceptable. Breaking the pencil sharpener down into subcomponents, e.g., the base, blades, handle, and assembly may modify the bid criteria. Then bid criteria for one or more of the subcomponents may be established. The bid criteria may include performance, functional, and/or cost objectives. Then the modified bid criteria, which include the established bid criteria associated with one or more of the sub-components, may be established.

In one embodiment, the system is a universal bid solicitation and itemized breakdown procurement process. For example, in procuring a wash booth, a bid request may be desired for the entire wash booth (e.g. the component) and may be required for each individual part, down do the nominal element. The bids may come back that is acceptable for each component in which case the process ends. One or more of the bids may come back as not acceptable in which case detailed engineering drawings and bid specifications may be used to break the components of the wash booth down into smaller components e.g. subcomponents. Each of these subcomponents may be offered for bid submissions, for purchase, fabrication, and/or the assembly of other sub-components to components. These components may have detailed engineering drawings that result in the supplier not having a need to design or engineer the specification, resulting in a reduced cost to the supplier. The supplier may return a bid that has a fabrication cost and part cost. A fabrication cost is the cost of producing the item. In this instance, the entire bid may be accepted or just the fabrication cost or part cost accepted. In some instances the fabrication cost may be acceptable but the part cost too high, in which case the fabrication bid may be accepted and the part procured from another source and either shipped to the supplier for assembly or procured from another source and assembled at an alternative location.

What is claimed is:

1. A method of procuring a component, comprising the steps of:
establishing a bid criteria for said component;
establishing a first bid request in response to said bid criteria;
identifying at least one potential supplier for said component;
submitting said bid request to said at least one potential supplier;
receiving a bid response from at least one potential supplier;
comparing said bid response with said bid criteria;
determining said bid response is undesirable in response to said comparison;
modifying said bid criteria in response to said bid response being undesirable;
establishing a second bid request in response to said modified bid criteria;
identifying at least one-second potential supplier;
submitting said second bid request to said at least one-second potential supplier;
receiving a bid response from at least one of said second potential suppliers; and
selecting at least one of said second potential suppliers in response to said second bid response.

2. The method as set forth in claim 1, wherein the step of modifying said bid criteria includes the steps of:
establishing a plurality of subcomponents, said subcomponents forming at least a portion of said component; and
modifying said bid criteria in response to said plurality of subcomponents.

3. A method, as set forth in claim 2, wherein the step of modifying said bid criteria includes the step of modifying said bid criteria in response to at least one of a design, a function, and a cost, associated with at least one of said subcomponents.

4. A method, as set forth in claim 3, wherein the step of establishing said second bid request includes the step of establishing said second bid request in response to said at least one of said subcomponents.

5. A method, as set forth in claim 4, wherein the step of establishing said second bid request includes the step of requesting at least one of a purchase of at least one of said subcomponents, a fabrication of at least one of said subcomponents, and an assembly of said subcomponents to form said component.

6. A method, as set forth in claim 5, further comprising the steps of:
assembling said component with a second component; and
assembling a system in response to said component assembly.

7. A computer based method of procuring a component, comprising the steps of:
establishing a bid criteria for a component;
establishing a bid request in response to said bid criteria;
posting said bid request on a web site;
receiving a bid response from at least one potential supplier;
selecting at least one potential supplier to supply said component in response to said bid response;
procuring said component from said supplier; and
integrating said component with a system, said system including at least a second component.

8. A computer based method, as set forth in claim 7, wherein said bid request is an open bid request.

9. A computer based method, as set forth in claim 8, further comprising the steps of:
comparing said bid response with said bid criteria;
modifying said bid criteria in response to said bid response being an undesirable bid;
establishing a second bid request in response to said modified bid criteria;
establishing at least one second potential supplier;
submitting said second bid request to said at least one-second potential suppliers;
receiving a second bid response from at least one of said at least one second potential supplier.

10. A computer based method, as set forth in claim 9, wherein the step of selecting one of said at least one potential supplier, includes the step of selecting one of said at least one potential suppliers in response to said second bid response.

11. A method of procuring at least one component associated with a custom system, comprising the steps of:
establishing a custom system design, said design including a plurality of components;
establishing a bid criteria for at least one of said plurality of components;
establishing a bid request in response to said bid criteria;
identifying at least one potential supplier for said at least one of said plurality of components;
submitting said bid request to said at least one potential supplier;
receiving a bid response from at least one of said potential supplier;
comparing said bid response with said bid criteria;
modifying said bid criteria in response to said bid response being an undesirable bid;
establishing a second bid request in response to said modified bid criteria;
establishing at least one second potential supplier;
submitting said second bid request to said at least one second potential suppliers;
receiving a second bid response from at least one of said second potential supplier; and
selecting one of said second potential suppliers to supply said component, in response to said second bid response
